(19) United States
(12) Patent Application Publication
(10) Pub. No.: US 2026/0274226 A1
(43) Pub. Date: Sep. 17, 2026

(54) Brake System For All-Terrain Vehicle

(71) Applicant: Zhejiang CFMOTO Power Co., Ltd., Hangzhou (CN)

(72) Inventors: Xufeng Ding, Hangzhou (CN); Hang Li, Hangzhou (CN); Jingjie Cheng, Hangzhou (CN); Guanglin Wang, Hangzhou (CN)

(21) Appl. No.: 19/564,839

(22) Filed: Mar. 12, 2026

(30) Foreign Application Priority Data
Mar. 13, 2025 (CN) 202510299912.1
Mar. 13, 2025 (CN) 202510300730.1

(51) Int. Cl. B60T 13/14; B60T 7/04; B60T 7/08

(52) U.S. Cl. CPC B60T 13/141; B60T 7/04; B60T 7/08; B60T 13/148

(57) ABSTRACT

A hydraulic brake valve in an ATV brake system has rear and front pistons slidable within a valve body. The front piston divides a chamber of the valve body into a front chamber area and an intermediate chamber area between the pistons. When depressing a brake pedal moves the rear piston through a foot control rod, brake fluid from the intermediate chamber area activates rear-wheel brake assemblies, and the intermediate spring moves the front piston so brake fluid from the front chamber area activates the front-wheel brake assemblies. Pressing of the handbrake lever when the brake pedal is not being pressed controls only the front-wheel brake assemblies.

### RELATED APPLICATION INFORMATION

The present application claims the benefit of priority to Chinese Patent Application No. 202510299912.1, filed with the Chinese Patent Office on March 13, 2025, and Chinese Patent Application No. 202510300730.1, filed with the Chinese Patent Office on March 13, 2025. The entire contents of the above-referenced applications are incorporated herein by reference.

### FIELD OF THE DISCLOSURE

The present application relates to the field of vehicle braking, and more particularly, to a brake system for an all-terrain vehicle.

### BACKGROUND OF THE DISCLOSURE

To support the high maneuverability of all-terrain vehicles (ATVs) and their usage requirements in complex environments, a brake system for all-terrain vehicle converts force generated by a brake pedal and/or a handbrake into a hydraulic pressure. The hydraulic pressure is then transmitted to each wheel brake through a series of mechanisms, thereby slowing down or stopping the ATV.

In the case of executing braking of the ATV through the brake pedal, only one hydraulic brake valve is needed to transmit brake fluid pressure brake calipers corresponding to each of the four wheels, so that brake calipers can clamp the respective brake discs. At present, an existing ATV brake system adopts a control scheme to brake the four wheels by the brake pedal and brake the two front wheels by the handbrake, but such control scheme is realized by cooperation of a hydraulic distribution valve and a separate hydraulic brake valve. Based on the above cooperative control scheme, the functions of the brake pedal and the handbrake can be realized without any interference therebetween. For example, the hydraulic distribution valve is arranged between the hydraulic brake valve and the brake calipers corresponding to the front wheels, and the pressure generated by the handbrake is transmitted to the brake calipers corresponding to the front wheels through the hydraulic distribution valve. The pressure generated by the brake pedal is partially applied directly to the brake calipers corresponding to the rear wheels through the hydraulic brake valve, and is further partially applied to the brake calipers corresponding to the front wheels through the hydraulic distribution valve. However, the structure of the ATV brake system that achieves hydraulic distribution through both the hydraulic brake valve and the hydraulic distribution valve is relatively complex, and many brake fluid pipelines may be required. The complexity and increased number of brake fluid pipelines increase risk of local leakage in the ATV brake system, which can seriously impair braking performance.

### SUMMARY OF THE INVENTION

In view of the above shortcomings of related arts, the purpose of the present invention is to provide a brake system for all-terrain vehicle. The hydraulic brake valve of the system is integrated with a hydraulic distribution function, such that the quantity of components required for hydraulic transmission in the brake system for all-terrain vehicle may be reduced, thereby improving the airtightness of the system and allowing the braking effect to be stable.

To achieve the above purposes, the present application adopts following technical solution.

A brake system for an all-terrain vehicle includes a hydraulic brake valve, two rear-wheel brake assemblies, two front-wheel brake assemblies, a brake pedal and a handbrake. The hydraulic brake valve includes at least rear and front pistons, an intermediate spring and a foot control rod all at least partially within a valve body. The valve body defines a chamber having an axis. The valve body further defines a handbrake fluid input port, a rear output port, a front output port and a brake fluid supplement port. Each of the handbrake fluid input port, the rear output port, the front output port, and the brake fluid supplement port are in fluid communication with the chamber. The rear piston is slidably received in the chamber of the valve body for movement along the axis. The foot control rod is coupled to the rear piston. The front piston is slidably received in the chamber of the valve body for movement along the axis. The front piston divides the chamber into a front chamber area forward of the front piston and an intermediate chamber area between the front piston and the rear piston. The front output port is in fluid communication with the front chamber area. The rear output port is in fluid communication with the intermediate chamber area. The intermediate spring is received in the intermediate chamber area of the valve body. The intermediate spring transmits spring force between the rear piston and the front piston, so when the rear piston moves due to the foot control rod, the intermediate spring pushes on the front piston. The two rear-wheel brake assemblies are in fluid communication with the intermediate chamber area through the rear output port and through rear brake fluid delivery pipelines. The two front front-wheel brake assemblies are in fluid communication with the front chamber area through the front output port and through front brake fluid delivery pipelines. The brake pedal coupled to the foot control rod, such that pressing of the brake pedal can directly move the rear piston to control the rear-wheel brake assemblies and can through the intermediate spring move the front piston to control the front-wheel brake assemblies. The handbrake has a handbrake lever, and is in fluid communication with the handbrake fluid input port through a handbrake fluid delivery pipeline. Pressing of the handbrake lever when the brake pedal is not being pressed controls only the front-wheel brake assemblies.

In another aspect, the front piston defines at least one front compensation hole. Depending upon axial position of the front piston, the handbrake fluid input port is either in bi-directional fluid communication with the front chamber area through the front compensation hole or unidirectionally sealed from the front chamber area so brake fluid can flow only from the handbrake fluid input port into the front chamber area.

In another aspect, the invention involves an all-terrain vehicle using the brake system. The all-terrain vehicle includes a frame, a suspension system, a plurality of wheels and a steering system. The suspension system is connected to the frame. The plurality of wheels is connected to the suspension system and include two front wheels and two rear wheels. The steering system is connected to the two front wheels and includes a handlebar. The handbrake lever is supported on the handlebar.

### BRIEF DESCRIPTION OF THE DRAWINGS

FIG. 1 is a front left perspective view of an all-terrain vehicle according to a preferred embodiment of the present invention;

FIG. 2 is a schematic view of a brake system used on the all-terrain vehicle of FIG. 1;

FIG. 3 is a perspective view, in partial cross-section, of the hydraulic brake valve used in the brake system of FIG. 2;

FIG. 4 is an exploded perspective view of the hydraulic brake valve of FIGS. 2 and 3;

FIG. 5 is a side cross-sectional view of the hydraulic brake valve of FIGS. 2-4 with the pistons in the initial, non-braking position;

FIG. 6 is a side cross-sectional view of the hydraulic brake valve of FIGS. 2-5 with both pistons in a braking position for braking both the front and rear wheels of the all-terrain vehicle of FIG. 1;

FIG. 7 is a flowchart of the hydraulic brake valve of FIGS. 2-6 executing a first working condition (corresponding to FIG. 6);

FIG. 8 is a flowchart of the hydraulic brake valve of FIGS. 2-6 executing a second working condition (corresponding to FIG. 6);

FIG. 9 is a flowchart of the hydraulic brake valve of FIGS. 2-6 executing a third working condition (corresponding to FIG. 5); and

FIG. 10 is a flowchart of the hydraulic brake valve of FIGS. 2-6 executing a fourth working condition (which could correspond to FIG. 5 or FIG. 6 at different times).

### DETAILED DESCRIPTION

In order to enable a skilled in the art to better understand the present invention, the following will provide a clear and complete description of one or more preferred embodiments and with reference to the attached figures.

It should be noted that the directional terms such as up, down, left, right, front, and rear, with the exception of the distinction between front wheels and rear wheels, as well as ordinal numerals such as “first” and “second” mentioned in the description, are based on the accompanying drawings and introduced for ease of description, but not intended to imply any limitation on the order or orientation of the related components. The embodiments are only used to help understand the method and core idea of the present invention, but not intended to limit the present invention in any form.

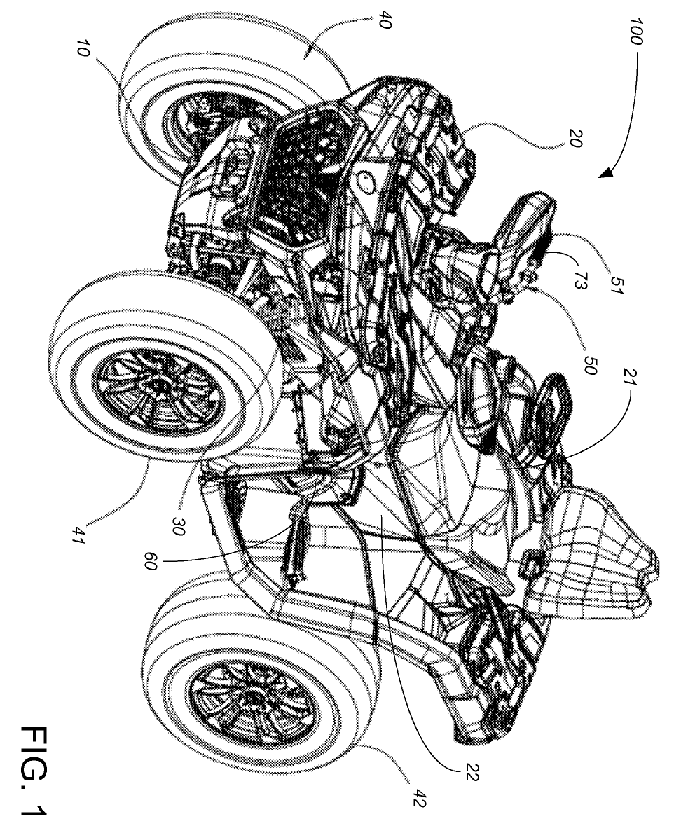

Referring to FIG. 1, an all-terrain vehicle 100 in accordance with the present invention includes a frame 10, a vehicle body cover 20, a suspension system 30, a plurality of wheels 40, and a steering system 50. The vehicle body cover 20 at least partially covers the frame 10. The vehicle body cover 20 includes at least one seat 21 and a body side panel 22 at least partially concealing an engine 60 (or motor). In other embodiments, the vehicle body cover may further include an engine compartment top cover (not shown), a trunk lid (not shown), a vehicle door (not shown), a fender (not shown), a roof canopy (not shown), etc. The suspension system 30 is connected between the frame 10 and the plurality of wheels 40, so the wheels 40 support the frame 10 through the suspension system 30. The suspension system 30 transmits forces between the frame 10 and the plurality of wheels 40 while reducing vibration caused by uneven ground surfaces during traveling of the all-terrain vehicle 100. At least portions of the plurality of wheels 40 are located below the frame 10 to contact the ground. At least some of the wheels 40 receive torque from the engine 60 to cause the all-terrain vehicle 100 to move. The plurality of wheels 40 preferably include two front wheels 41 and two rear wheels 42. The preferred steering system 50 includes a handlebar 51 coupled to the front wheels 41 for turning of the all-terrain vehicle 100.

The all-terrain vehicle 100 includes a brake system 70 used to slow down or stop the vehicle 100. The preferred brake system 70 includes a hydraulic brake valve 71, a plurality of brake assemblies 72 including two front brake assemblies 721 (one for each of the front wheels 41) and two rear brake assemblies 722 (one for each of the rear wheels 42), a handbrake 73, a brake pedal 74, a brake fluid reservoir 75, an anti-locking mechanism 76, and brake lines 77. The handbrake 73 is preferably mounted on the handlebar 51. The brake pedal 74 is preferably mounted on the frame 10 adjacent one of the driver’s feet. In operation, the handbrake 73 is used to primarily control only the front brake assemblies 721, while the brake pedal 74 is used to primarily control all four brake assemblies 721, 722 simultaneously. The brake lines 77 are pipelines for transporting/fluid communication using brake fluid, which can be flexible, rigid or a combination of some flexible components and some rigid components.

The hydraulic brake valve 71 includes a valve body 711, two pistons including a front piston 712 and a rear piston 713, a foot control rod 714, and at least one and more preferably two springs including a front spring 715 and an intermediate spring 716. The valve body 711 defines a chamber 7111 which provides space for piston movement and brake fluid flow inside the chamber 7111. The pistons 712, 713 are positioned in the chamber 7111 and are capable of sliding movement within the chamber 7111 along an axis 101. The intermediate spring 716 is used to bias the front piston 712 following movement of the rear piston 713. The springs 715, 716 are also both used to bias the pistons 712, 713 back toward their initial, non-braking positions. After the pistons 712, 713 move to induce braking, the pistons 712, 713 can return to their original positions under forces of the springs 715, 716. One end of the foot control rod 714 is connected to the rear piston 713, and the other end of the foot control rod 714 is connected to the brake pedal 74. The foot control rod 714 is capable of driving the rear piston 713 to move under control of the brake pedal 74, and movement of the rear piston 713 induces movement of the front piston 712 through the spring force of the intermediate spring 716. The chamber 7111 can be considered to have an intermediate chamber area 7111a between the two pistons 712, 713 and a front chamber area 7111b forward of the front piston 712.

The valve body 711 further defines a handbrake fluid input port 7112, a rear output port 7113, a front output port 7114, and a brake fluid supplement port 7115 each of which is in fluid communication with the chamber 7111. More specifically, the handbrake fluid input port 7112 and the front output port 7114 are in fluid communication with and through the front chamber area 7111b, while the brake fluid supplement port 7115 and the rear output port 7113 are in fluid communication with and through the intermediate chamber area 7111a. The handbrake fluid input port 7112 is in fluid communication with the handbrake 73 through a handbrake fluid delivery pipeline 771. The rear output port 7113 communicates with pressure ports 7221 of the rear-wheel brake assemblies 722 through rear brake fluid delivery pipelines 772. The front output port 7114 communicates with pressure ports 7211 of the front-wheel brake assemblies 721 through front brake fluid delivery pipelines 773. The foot control rod 714 drives the rear piston 713 to move under control of the brake pedal 74, thereby causing brake fluid to leave the chamber 7111 through the rear output port 7113 and the front output port 7114. The handbrake fluid input port 7112 is used to receive pressure/flow generated by the handbrake 73, thereby causing brake fluid to leave the chamber 7111 through the front output port 7114.

The brake fluid reservoir 75 of the preferred brake system 70 stores brake fluid. The brake fluid supplement port 7115 is connected to the brake fluid reservoir 75, so the brake fluid reservoir 75 can at times supplement brake fluid in the chamber 7111 through the brake fluid supplement port 7115. At other times when the pressure in the chamber 7111 increases, the hydraulic brake valve 71 can force at least a portion of the brake fluid back into the brake fluid reservoir 75 through the brake fluid supplement port 7115. Thus, pressure in the hydraulic brake valve 71 can be at least partially balanced during operation through the brake fluid reservoir 75 connected to the brake fluid supplement port 7115.

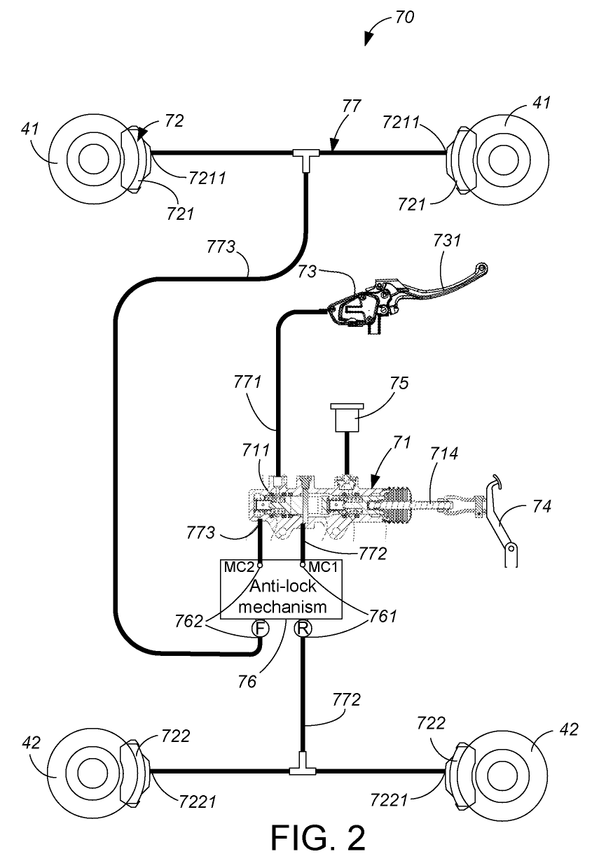

As shown in FIG. 2, the anti-locking mechanism 76 of the preferred brake system 70 is set between the hydraulic brake valve 71 and the brake assemblies 72. When the vehicle 100 brakes suddenly or brakes on a road surface with low adhesion, the anti-locking mechanism 76 can prevent the wheels 40 from locking up with no rotation while the vehicle 100 is still moving. Keeping the wheels 40 rotating during high-speed braking maintains greater steering ability for the vehicle 100, thereby improving driving safety. The preferred anti-locking mechanism 76 has two separate sets of hydraulic circuit interfaces, namely, a rear set of anti-locking interfaces 761 between the rear output port 7113 and the rear-wheel brake assemblies 722, and a front set of anti-locking interfaces 762 between the front output port 7114 and the front-wheel brake assemblies 721. The anti-locking mechanism 76 can thereby directly control hydraulic pressure distribution to the rear-wheel brake assemblies 722 and the front-wheel brake assemblies 721.

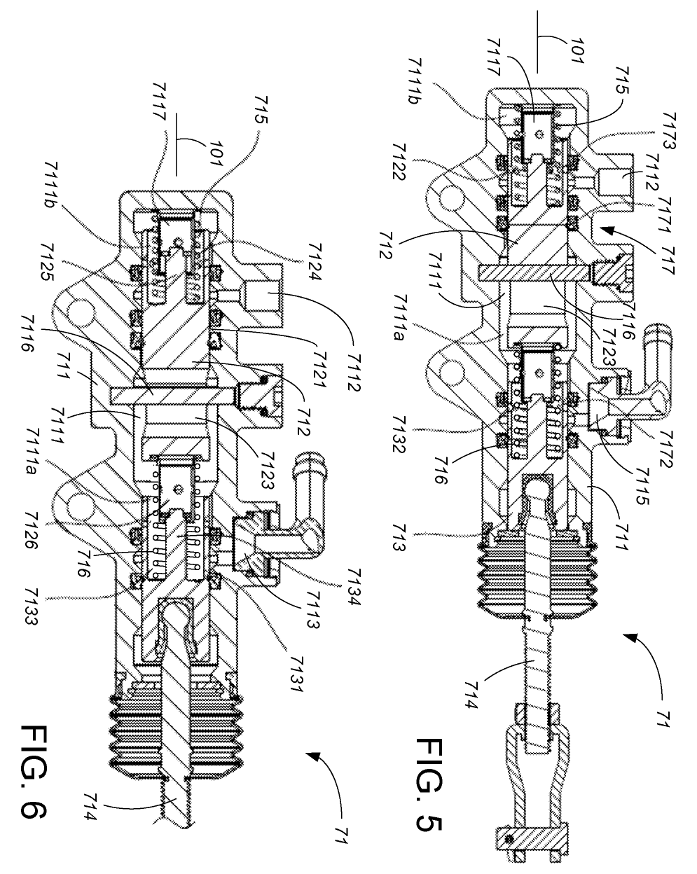

In the preferred brake system 70, the hydraulic brake valve 71 does not receive any external force when there is no braking operation. Both of the pistons 712, 713 are located at their initial non-braking positions within the chamber 7111 as depicted in FIG. 5. In their initial non-braking positions, both of the springs 715, 716 are slightly preloaded, with the front spring 715 preloaded slightly more than the intermediate spring 716. When the driver steps on the brake pedal 74, the brake pedal 74 transmits force to the hydraulic brake valve 71 through the foot control rod 714. The foot control rod 714 drives the piston 712 to move axially inside the chamber 7111 under the pressure of the brake pedal 74, thereby causing brake fluid to leave the chamber 7111 through one or both of the rear output port 7113 and the front output port 7114. Brake fluid flow through the rear output port 7113 induces flow into the pressure ports 7221 of the rear-wheel brake assemblies 722, which provides hydraulic pressure required for braking the rear wheels 42. Brake fluid flow through the front output port 7114 induces flow through the pressure ports 7211 of the front-wheel brake assemblies 721, which provides hydraulic pressure required for braking the front wheels 41. During handbrake operation, the handbrake 73 transmits pressure to the chamber 7111 through the handbrake fluid input port 7112, and brake fluid flow through the front output port 7114 induces flow through the pressure ports 7211 of the front-wheel brake assemblies 721.

When the input from the brake pedal 74 and/or the handbrake 73 changes, the pistons 712, 713, the springs 715, 716, and the foot control rod 714 cooperatively control hydraulic flow and pressure distribution of brake fluid at one or both output ports 7113, 7114. Thus, the front-wheel brake assemblies 721 and/or the rear-wheel brake assemblies 722 are controlled through different control methods. The hydraulic brake valve 71 of the brake system 70 has an integrated hydraulic distribution, reducing the quantity of components required for hydraulic transmission, improving airtightness of the system 70, and allowing stable braking effect.

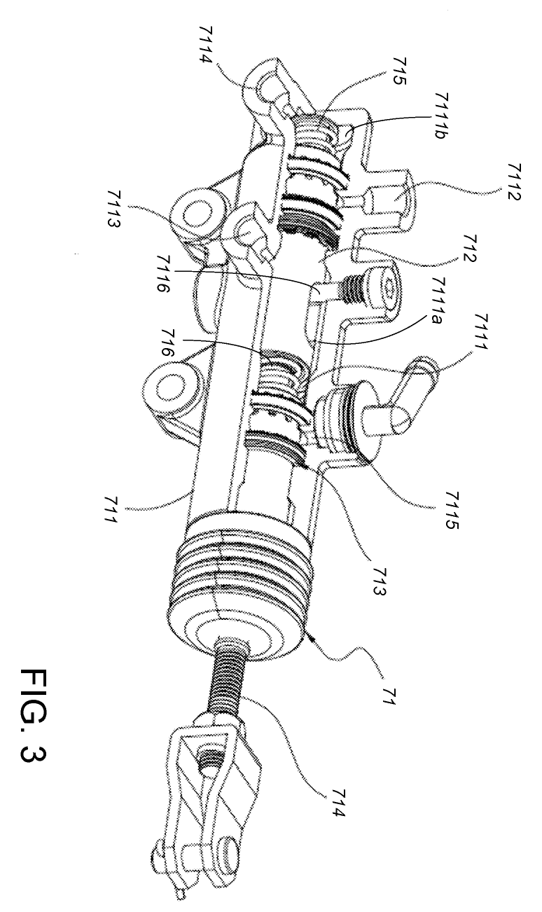

As shown in FIGS. 3 to 6 and called out in FIG. 5, the hydraulic brake valve 71 further includes a plurality of seals 717. The seals 717 are installed in the chamber 7111 and fixed to the valve body 711. The plurality of seals 717 includes a chamber seal 7171, a rear piston seal 7172, and a front piston seal 7173. The chamber seal 7171 cooperates with the front piston 713 to divide the chamber 7111 into the intermediate chamber area 7111a and the front chamber area 7111b. The rear piston seal 7172 engages around the rear piston 713, and the front piston seal 7173 engages around the front piston 712. The intermediate chamber area 7111a continually communicates with the rear output port 7113, and the front chamber area 7111b continually communicates with the front output port 7114. The rear piston 713 has a rear piston sidewall 7131 provided with one or more rear compensation holes 7132 therethrough, and the front piston 712 has a front piston sidewall 7121 provided with one or more front compensation holes 7122 therethrough. When the rear piston 713 is in the initial non-braking position, the brake fluid supplement port 7115 can bi-directionally communicate with the intermediate chamber area 7111a through the rear compensation hole(s) 7132. Thus, in the non-braking position, the rear compensation hole(s) 7132 achieve(s) pressure balance between the intermediate chamber area 7111a and the brake fluid supplement port 7115. When the front piston 712 is in the initial non-braking position, the handbrake fluid input port 7112 can bi-directionally communicate with the front chamber area 7111b through the front compensation hole(s) 7122. Thus, in the non-braking position, the front compensation hole(s) 7122 achieve(s) pressure balance between the front chamber area 7111a and the handbrake fluid input port 7112. With both pistons 712, 713 in their initial non-braking positions, inflow/outflow of brake fluid can happen in the intermediate chamber area 7111a and the front chamber area 7111b independently. If multiple front compensation holes 7122 and/or multiple rear compensation holes 7132 are provided, then the multiple compensation holes 7122 and/or 7132 are preferably circumfentially spaced about the axis 101.

In different braking modes, the flow path of brake fluid is controlled through cooperation and relative positioning between the rear piston seal 7172 and the rear compensation hole(s) 7132 and/or cooperation and relative positioning between the front piston seal 7173 and the front compensation hole(s) 7122. Fluid pressure in the intermediate chamber area 7111a or the front chamber area 7111b changes, thereby controlling output of different brake fluid outlets 7113, 7114 and precisely achieving the desired hydraulic brake control. The preferred front piston seal 7173 has a unidirectional pressure building function, and even if the front piston 712 is at a forward position, brake fluid from the handbrake fluid input port 7112 can enter the front chamber area 7111b past the front piston seal 7132 if sufficient handbrake pressure is applied. The unidirectional front piston seal 7173 can be shaped as either a C-type bowl or an E-type bowl.

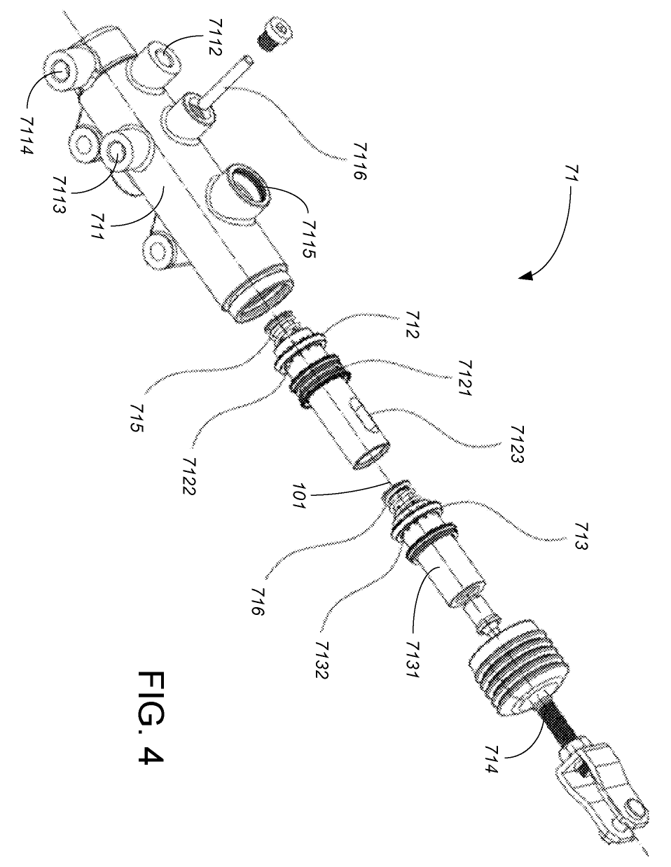

As shown in FIG. 4, the front piston 712 preferably includes a limiting hole 7123 extending radially into and more preferably through its sidewall 7121, and the limiting hole 7123 preferably has an oblong shape, longer in the axial direction. A limiting pin 7116, preferably having a cylindrical shape, is fixed to the valve body 711 so as to extend transversely into the limiting hole 7123, limiting maximum axial moving range of the front piston 712. In the preferred embodiment, when the front piston 712 is in an initial, non-braking position, the limiting pin 7116 is at a front end of the limiting hole 7123, preventing the front piston 712 from moving rearward regardless of how much pressure is subsequently applied to the front brakes 721 through the handbrake 73. The limiting pin 7116 could alternatively be replaced by a slot-typed limiting component (not shown), an elastic limiting component (not shown), a fixing-block-typed limiting component (not shown), etc. Another alternative embodiment uses another limiting pin or other limiting component to limit maximum axial moving range of the rear piston 713.

By movement of the pistons 712, 713 and resultant compression of one or both springs 715, 716, the rear compensation hole(s) 7132 and the front compensation hole(s) 7122 can be blocked by the rear piston seal 7172 and the front piston seal 7173, respectively, such that fluid pressure can be built in the intermediate chamber area 7111a and/or the front chamber area 7111b.

In the preferred embodiment, the rear piston 713 has a rear piston annular recess 7133 extending axially which partially receives the intermediate spring 716, and the front piston 712 has a front piston annular recess 7124 which partially receives the front spring 715. Both annular recesses 7133, 7124 face forwardly, helping to retain alignment of the springs 716, 715, resulting in smooth sliding of the pistons 713, 712. The rear piston annular recess 7133 is in fluid communication with the intermediate chamber area 7111a, and the front piston annular recess 7124 is in fluid communication with the front chamber area 7111b.

In the preferred embodiment, the elastic coefficient of the intermediate spring 716 is greater than the elastic coefficient of the front spring 715, while preload on the front spring 715 is equal to or greater than preload on the intermediate spring 716. When the rear piston 712 moved by the foot control rod 714, the front piston 712 can move synchronously. It should be noted that if preload on the front spring 715 is too much greater than preload on the intermediate spring 716, when the rear piston 713 is initially moved by the foot control rod 714, then the front piston 712 will remain stationary for too long, which results in an insufficient braking force for the front-wheel brake assemblies 721 and affects the foot braking effect of the all-terrain vehicle 100. With the preferred embodiments, the foot control rod 714 under control of the brake pedal 74 can initiate movement of the front piston 712 almost immediately following the start of movement of the rear piston 715. Thus, pressure can build substantially synchronously in the intermediate chamber area 7111a and the front chamber area 7111b, thereby allowing the front-wheel brake assemblies 721 and the rear-wheel brake assemblies 722 to operate substantially synchronously.

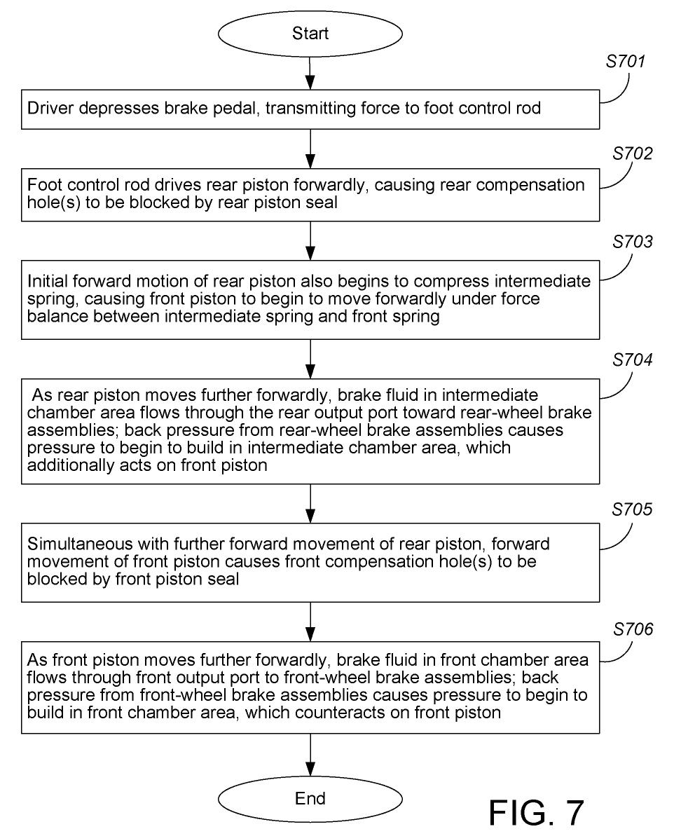

As called out in FIG. 7, the pistons 712, 713 preferably each include a center slide guide 7125, 7134 extending axially which defines the inside of the respective annular recess 7124, 7133. The front piston center slide guide 7125 is received in clearance fit in a valve body positioning sleeve 7117 fixed on the valve body 711 and extending axially into the front chamber area 7111a. The rear piston center slide guide 7134 is received in clearance fit in a front piston positioning sleeve 7126 extending axially and rearwardly off the front piston 712 into the intermediate chamber area 7111b. Interaction between each slide guide 7125, 7134 and its respectively mating positioning sleeve 7117, 7126 further helps to maintain non-binding, sliding axial movement of each piston 712, 713, reducing wear in the hydraulic brake valve 71.

Based on different external inputs, the hydraulic brake valve 71 can respond to force generated by the handbrake 73 and/or the brake pedal 74 and perform four working conditions as follows.

As shown in FIG. 7, the first working condition is that only force generated by the brake pedal 74 is applied onto the hydraulic brake valve 71. The brake system 70 performs steps as follows.

In step S701, the driver depresses the brake pedal 74, and the brake pedal 74 transmits force to the foot control rod 714.

In step S702, the foot control rod 714 drives the rear piston 7131 to move forwardly, thereby causing the rear compensation hole(s) 7132 to be blocked by the rear piston seal 7172.

In step S703, the initial forward motion of the rear piston 713 also begins to compress the intermediate spring 716, causing the front piston 712 to begin to move forwardly under a force balance between the intermediate spring 716 and the front spring 715.

In step S704, as the rear piston 713 moves further forwardly, brake fluid in the intermediate chamber area 7111a flows through the rear output port 7113 toward the rear-wheel brake assemblies 722, braking the rear wheels 42. Back pressure from the rear-wheel brake assemblies 722 causes pressure to begin to build in the intermediate chamber area 7111a, which additionally acts on the front piston 712.

In step S705, simultaneous with the further forward movement of the rear piston 713, forward movement of the front piston causes the front compensation hole(s) 7122 to be blocked by the front piston seal 7173.

In step S706, as the front piston 712 moves further forwardly, brake fluid in the front chamber area 7111a flows through the front output port 7114 toward the front-wheel brake assemblies 722, braking the front wheels 41. Back pressure from the front-wheel brake assemblies 722 causes pressure to begin to build in the front chamber area 7111a, which counteracts on the front piston 712.

It should be noted that even though the external input is only from the brake pedal 74, pressure builds in the intermediate chamber area 7111a and the front chamber area 7111b substantially simultaneously. Pressure balance between the front chamber area 7111b and the intermediate chamber area 7111a is subject to spring force balance between the front spring 715 and intermediate spring 716. The system designer can control the foot braking force on the front-wheel brake assemblies 721 relative to the foot braking force on the rear-wheel brake assemblies 722 by appropriate selection of the spring constant of the front spring 715 relative to the spring constant of the intermediate spring 716, simultaneously braking the front wheels 41 and the rear wheels 42 through the brake pedal 74 at desired brake force ratio.

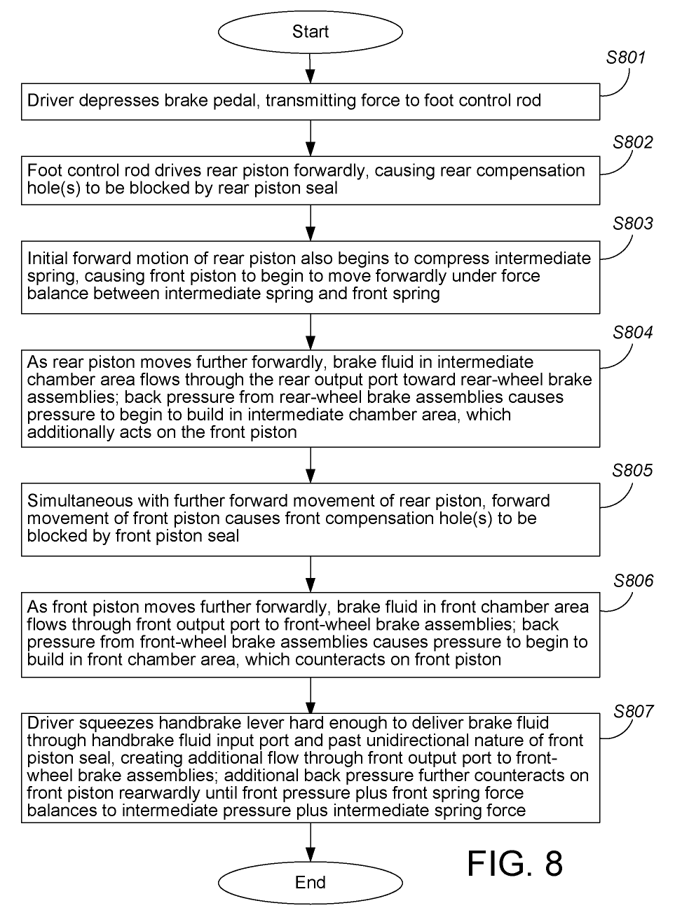

As shown in FIG. 8, the second working condition is that force generated by the brake pedal 74 first acts on the hydraulic brake valve 71, and then pressure generated by the handbrake 73 acts on the hydraulic brake valve 71. The brake system 70 performs steps as follows.

In step S801, the driver depresses the brake pedal 74, and the brake pedal 74 transmits force to the foot control rod 714.

In step S802, the foot control rod 714 drives the rear piston 713 to move forwardly, thereby causing the rear compensation hole(s) 7132 to be blocked by the rear piston seal 7172.

In step S803, the initial forward motion of the rear piston 713 also begins to compress the intermediate spring 716, causing the front piston 712 to begin to move forwardly under a force balance between the intermediate spring 716 and the front spring 715.

In step S804, as the rear piston 713 moves further forwardly, brake fluid in the intermediate chamber area 7111a flows through the rear output port 7113 toward the rear-wheel brake assemblies 722, braking the rear wheels 42. Back pressure from the rear-wheel brake assemblies 722 causes pressure to begin to build in the intermediate chamber area 7111a, which additionally acts on the front piston 712.

In step S805, simultaneous with the further forward movement of the rear piston 713, forward movement of the front piston 712 causes the front compensation hole(s) 7122 to be blocked by the front piston seal 7173.

In step S806, as the front piston 712 moves further forwardly, brake fluid in the front chamber area 7111a flows through the front output port 7114 toward the front-wheel brake assemblies 721, braking the front wheels 41. Back pressure from the front-wheel brake assemblies 721 causes pressure to begin to build in the front chamber area 7111a, which counteracts on the front piston 712.

In step S807, the driver squeezes a handbrake lever 731 of the handbrake 73. Provided the driver squeezes the handbrake lever 731 hard enough, brake fluid is delivered through the handbrake fluid input port 7112, which passes the unidirectional nature of the front piston seal 7173, thereby creating additional flow through the front output port 7114 to the front-wheel brake assemblies 721 and additional front wheel braking. The additional front wheel braking adds to the back pressure in the front chamber area 7111b. The additional back pressure further counteracts on the front piston 712, pushing the front piston 712 rearwardly until pressure in the front chamber area 7111b together with compressive force of the front spring 715 balances against pressure in the intermediate chamber area 7111a together with compressive force of the intermediate spring 716. Thus, the hydraulic brake valve 71 achieves a state of pressure balance.

Note that, due to brake fluid flow past the unidirectional front piston seal 7173, an additional braking effect will remain until the brake pedal 74 is fully released. For instance, if the driver begins a slow relatively constant braking using the brake pedal 74, and then gives a quick, hard squeeze of the handbrake lever 731 while holding the slow braking of the brake pedal 74, the subsequent braking of the brake pedal 74 (prior to full release of the brake pedal 74) will brake all the wheels 40 at a heightened brake pressure (as compared to brake pressure prior to the quick, hard squeeze), as if the handbrake lever 731 was also being held. Only upon release of the brake pedal 74 will the front piston 712 retreat to its initial position, allowing back flow through the front compensation hole(s) 7122 to reset the brake system 70.

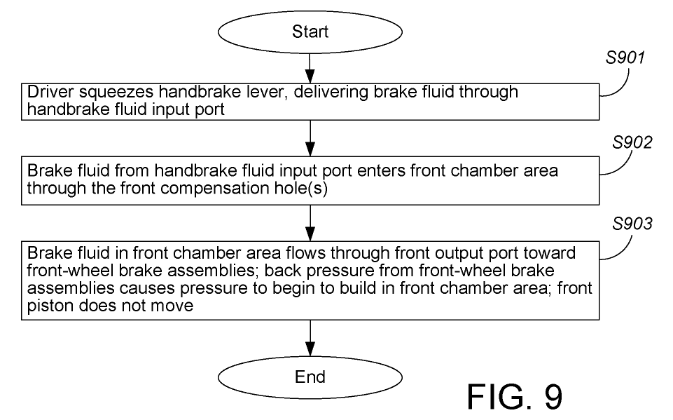

As shown in FIG. 9, the third working condition is that only pressure generated by the handbrake 73 acts on the hydraulic brake valve 71. The brake system 70 performs steps as follows.

In step S901, the driver squeezes the handbrake lever 731 of the handbrake 73. Brake fluid is delivered through the handbrake fluid input port 7112.

In step S902, brake fluid from the handbrake fluid input port 7112 enters the front chamber area 7111b through the front compensation hole(s) 7122.

In step S903, brake fluid in the front chamber area flows through the front output port 7114 toward the front-wheel brake assemblies 721, braking the front wheels 41. Back pressure from the front-wheel brake assemblies 721 causes pressure to begin to build in the front chamber area. The front piston 712 does not move at this time, however, as the limit pin 7116 in the front end of the limiting hole 7123 prevents rearward movement of the front piston 712.

Throughout the third working condition, the front compensation hole(s) 7122 is/are not blocked by the front piston seal 7173, thereby allowing brake fluid to flow through the front compensation hole(s) 7122 in either direction. Control of front wheel braking is realized independently by the handbrake 73.

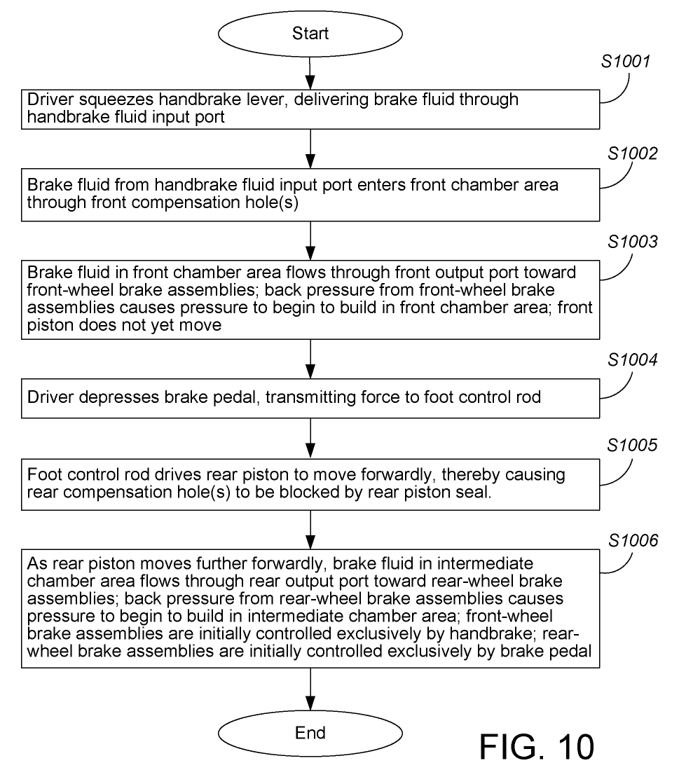

As shown in FIG. 10, the fourth working condition is that pressure generated by the handbrake 73 first acts on the hydraulic brake valve 71 and then force generated by the brake pedal 74 acts on the hydraulic brake valve 71. The brake system 70 performs steps as follows.

In step S1001, the driver squeezes the handbrake lever 731 of the handbrake 73. Brake fluid is delivered through the handbrake fluid input port 7112.

In step S1002, brake fluid from the handbrake fluid input port 7112 enters the front chamber area 7111b through the front compensation hole(s) 7122.

In step S1003, brake fluid in the front chamber area flows through the front output port 7114 toward the front-wheel brake assemblies 721, braking the front wheels 41. Back pressure from the front-wheel brake assemblies 721 causes pressure to begin to build in the front chamber area 7111b. The front piston 712 does not move, however, as the limiting pin 7116 in the front end of the limiting hole 7123 prevents rearward movement of the front piston 712.

In step S1004, the driver depresses the brake pedal 74, and the brake pedal 74 transmits force to the foot control rod 714.

In step S1005, the foot control rod 714 drives the rear piston 713 to move forwardly, thereby causing the rear compensation hole(s) 7132 to be blocked by the rear piston seal 7172.

In step S1006, as the rear piston 713 moves further forwardly, brake fluid in the intermediate chamber area 7111a flows through the rear output port 7113 toward the rear-wheel brake assemblies 722, braking the rear wheels 42. Back pressure from the rear-wheel brake assemblies 722 causes pressure to begin to build in the intermediate chamber area 7111a. At least initially upon applying force to the brake pedal 74, the front-wheel brake assemblies 721 are controlled exclusively by the handbrake 73, and the rear-wheel brake assemblies 722 are controlled exclusively by the brake pedal 74.

The front piston 712 only begins to move when back pressure from the rear-wheel brake assemblies 722 together with the compressive force of the intermediate spring 716 exceeds the back pressure from the front-wheel bake assemblies together with the compressive force of the front spring 715, and only after the front piston 712 begins to move does force on the brake pedal 74 begin to contribute to front wheel braking. Only after forward movement of the front piston 712 causes the front compensation hole(s) 7122 to be blocked by the front piston seal 7173 is pressure balance achieved.

In summary, the hydraulic brake valve 71 in accordance with the present invention integrates hydraulic distribution, reduces the quantity of components in the brake system 70, improves airtightness of the system 70, and allows stable braking effect.

It should be understood that for those skilled in the art, improvements or transformations may be made based on the above description, and all the improvements and transformations should be within the scope of claims attached to the present application.

1. A brake system for an all-terrain vehicle, comprising:
a hydraulic brake valve comprising:
a valve body defining a chamber having an axis, the valve body further defining a handbrake fluid input port, a rear output port, a front output port and a brake fluid supplement port, each of the handbrake fluid input port, the rear output port, the front output port, and the brake fluid supplement port being in fluid communication with the chamber;
a rear piston slidably received in the chamber of the valve body for movement along the axis;
a foot control rod coupled to the rear piston;
a front piston slidably received in the chamber of the valve body for movement along the axis, the front piston dividing the chamber into a front chamber area forward of the front piston and an intermediate chamber area between the front piston and the rear piston, the front output port being in fluid communication with the front chamber area and the rear output port being in fluid communication with the intermediate chamber area; and
an intermediate spring received in the intermediate chamber area of the valve body, the intermediate spring transmitting spring force between the rear piston and the front piston;
two rear-wheel brake assemblies in fluid communication with the intermediate chamber area through the rear output port and through rear brake fluid delivery pipelines;
two front front-wheel brake assemblies in fluid communication with the front chamber area through the front output port and through front brake fluid delivery pipelines;
a brake pedal coupled to the foot control rod, such that pressing of the brake pedal can directly move the rear piston to control the rear-wheel brake assemblies and can through the intermediate spring move the front piston to control the front-wheel brake assemblies; and
a handbrake in fluid communication with the handbrake fluid input port through a handbrake fluid delivery pipeline, the handbrake having a handbrake lever, such that pressing of the handbrake lever when the brake pedal is not being pressed controls only the front-wheel brake assemblies.

2. The brake system of claim 1, wherein the hydraulic brake valve further comprises a plurality of seals fixed to the valve body, the plurality of seals comprising a rear piston seal, a chamber seal, and a front piston seal, the rear piston seal extending around the rear piston, the chamber seal and the front piston seal both extending around the front piston.

3. The brake system of claim 2, wherein the rear piston defines at least one rear compensation hole, and wherein the brake fluid supplement port is, depending upon axial position of the rear piston, either in bi-directional fluid communication with the intermediate chamber area through the rear compensation hole or sealed from the intermediate chamber area by the rear piston seal.

4. The brake system of claim 3, wherein the front piston defines at least one front compensation hole, and wherein the handbrake fluid input port is, depending upon axial position of the front piston, either in bi-directional fluid communication with the front chamber area through the front compensation hole or unidirectionally sealed from the front chamber area by the front piston seal.

5. The brake system of claim 4, further comprising a front spring arranged between the front piston and the valve body, biasing the front piston toward the rear piston.

6. The brake system of claim 5, wherein preload on the front spring is equal to or greater than preload on the intermediate spring.

7. The brake system of claim 6, wherein the front piston defines a limiting hole, and wherein the hydraulic brake valve further comprises a limiting member fixed to the valve body and extending into the limiting hole, and wherein depending upon axial position of the front piston, the limiting member engages with the front piston to prevent further movement of the front piston toward the rear piston under preload of the front spring.

8. The brake system of claim 7, wherein, when the limiting member is in engaged contact with the front piston, the handbrake fluid input port is in bi-directional in fluid communication with the front chamber area through the front compensation hole.

9. The brake system of claim 8, wherein the limiting hole has an oblong shape, and wherein the limiting member is a cylindrical limiting pin.

10. The brake system of claim 5, wherein an elastic coefficient of the intermediate spring is greater than an elastic coefficient of the front spring.

11. The brake system of claim 5, wherein the front piston defines a front piston annular recess facing away from the rear piston, and wherein the front piston at least partially extends into the rear piston annular recess.

12. The brake system of claim 11, wherein the front piston comprises a front piston positioning sleeve extending axially off the front piston into the intermediate chamber area, wherein the rear piston comprises a rear piston center slideguide received in clearance fit in the front piston positioning sleeve.

13. The brake system of claim 1, wherein the rear piston defines a rear piston annular recess facing the front piston, and wherein the intermediate spring at least partially extends into the rear piston annular recess.

14. The brake system of claim 13, wherein the valve body comprises a valve body positioning sleeve extending axially into the front chamber area, wherein the front piston comprises a front piston center slideguide received in clearance fit in the valve body positioning sleeve.

15. The brake system of claim 1, further comprising a brake fluid reservoir in fluid communication with the brake fluid supplement port.

16. A brake system for an all-terrain vehicle, comprising:
a hydraulic brake valve comprising:
a valve body defining a chamber having an axis, the valve body further defining a handbrake fluid input port, a rear output port and a front output port, each of the handbrake fluid input port, the rear output port and the front output port being in fluid communication with the chamber;
a rear piston slidably received in the chamber of the valve body for movement along the axis;
a foot control rod coupled to the rear piston;
a front piston slidably received in the chamber of the valve body for movement along the axis, the front piston dividing the chamber into a front chamber area forward of the front piston and an intermediate chamber area between the front piston and the rear piston, the front output port being in fluid communication with the front chamber area and the rear output port being in fluid communication with the intermediate chamber area, wherein the front piston defines at least one front compensation hole, and wherein the handbrake fluid input port is, depending upon axial position of the front piston, either in bi-directional fluid communication with the front chamber area through the front compensation hole or unidirectionally sealed from the front chamber area so brake fluid can flow only from the handbrake fluid input port into the front chamber area;
an intermediate spring received in the intermediate chamber area of the valve body, the intermediate spring transmitting spring force between the rear piston and the front piston; and
a front spring arranged between the front piston and the valve body, biasing the front piston toward the rear piston;
two rear-wheel brake assemblies in fluid communication with the intermediate chamber area through the rear output port and through rear brake fluid delivery pipelines;
two front front-wheel brake assemblies in fluid communication with the front chamber area through the front output port and through front brake fluid delivery pipelines;
a brake pedal coupled to the foot control rod, such that pressing of the brake pedal can directly move the rear piston to control the rear-wheel brake assemblies and can through the intermediate spring move the front piston to control the front-wheel brake assemblies; and
a handbrake in fluid communication with the handbrake fluid input port through a handbrake fluid delivery pipeline, the handbrake having a handbrake lever, such that pressing of the handbrake lever when the brake pedal is not being pressed controls only the front-wheel brake assemblies.

17. The brake system of claim 16, wherein the valve body further comprises a brake fluid supplement port, wherein the rear piston defines at least one rear compensation hole, and wherein the brake fluid supplement port is, depending upon axial position of the rear piston, either in bi-directional fluid communication with the intermediate chamber area through the rear compensation hole or sealed from the intermediate chamber area by the rear piston seal.

18. The brake system of claim 17, wherein the hydraulic brake valve further comprises a limiting member fixed to the valve body, and wherein depending upon axial position of the front piston, the limiting member engages with the front piston to prevent further movement of the front piston toward the rear piston under preload of the front spring, such that, when neither the brake pedal nor the handbrake lever are being pressed, the brake fluid supplement port is in bi-directional fluid communication with the intermediate chamber area through the rear compensation hole and the front spring pushes the front piston against the limiting member with the handbrake fluid input port in bi-directional fluid communication with the front chamber area through the front compensation hole.

19. The brake system of claim 16, wherein preload on the front spring is equal to or greater than preload on the intermediate spring, and wherein an elastic coefficient of the intermediate spring is greater than an elastic coefficient of the front spring.

20. An all-terrain vehicle comprising:
a frame;
a suspension system connected to the frame;
a plurality of wheels connected to the suspension system, and comprising two front wheels and two rear wheels;
a steering system connected to the two front wheels and comprising a handlebar; and
a hydraulic brake system comprising:
a hydraulic brake valve comprising:
a valve body defining a chamber having an axis, the valve body further defining a handbrake fluid input port, a rear output port and a front output port, each of the handbrake fluid input port, the rear output port and the front output port being in fluid communication with the chamber;
a rear piston slidably received in the chamber of the valve body for movement along the axis;
a foot control rod coupled to the rear piston;
a front piston slidably received in the chamber of the valve body for movement along the axis, the front piston dividing the chamber into a front chamber area forward of the front piston and an intermediate chamber area between the front piston and the rear piston, the front output port being in fluid communication with the front chamber area and the rear output port being in fluid communication with the intermediate chamber area; and
an intermediate spring received in the intermediate chamber area of the valve body, the intermediate spring transmitting spring force between the rear piston and the front piston;
two rear-wheel brake assemblies in fluid communication with the intermediate chamber area through the rear output port and through rear brake fluid delivery pipelines, each of the rear-wheel brake assemblies being for braking one of the two rear wheels;
two front front-wheel brake assemblies in fluid communication with the front chamber area through the front output port and through front brake fluid delivery pipelines, each of the front-wheel brake assemblies being for braking one of the two front wheels;
a brake pedal coupled to the foot control rod, such that pressing of the brake pedal can directly move the rear piston to control the rear-wheel brake assemblies and can through the intermediate spring move the front piston to control the front-wheel brake assemblies; and
a handbrake in fluid communication with the handbrake fluid input port through a handbrake fluid delivery pipeline, the handbrake having a handbrake lever supported on the handlebar, such that pressing of the handbrake lever when the brake pedal is not being pressed controls only the front-wheel brake assemblies.
